(19) United States
(12) Patent Application Publication
(10) Pub. No.: US 2012/0294771 A1
(43) Pub. Date: Nov. 22, 2012

(54) PARTICULATE FILTER FOR VEHICLE AND EXHAUST SYSTEM USING THE SAME

(75) Inventor: Sungmu Choi, Seoul (KR)

(73) Assignee: Hyundai Motor Company, Seoul (KR)

(21) Appl. No.: 13/300,389

(22) Filed: Nov. 18, 2011

(30) Foreign Application Priority Data
May 18, 2011 (KR) 10-2011-0046889

(51) Int. Cl. B01J 19/00

(52) U.S. Cl. 422/170; 422/169

(57) ABSTRACT

A particulate filter may include a first layer composed of a first hydrocarbon trap absorbing hydrocarbon contained in an exhaust gas at a low temperature and a second layer composed of a first oxidizing catalyst oxidizing the hydrocarbon contained in the exhaust gas. The hydrocarbon absorbed at the first layer may be released at a high temperature, and the released hydrocarbon may be oxidized at the second layer to raise a temperature of the exhaust gas. An exhaust system may include an oxidation catalyst and the particulate filter. The oxidation catalyst may be a diesel oxidation catalyst comprising a third layer composed of a second hydrocarbon trap absorbing the hydrocarbon contained in the exhaust gas at a low temperature and a fourth layer composed of a second oxidizing catalyst oxidizing the hydrocarbon contained in the exhaust gas.

### CROSS-REFERENCE TO RELATED APPLICATION

The present application claims priority of Korean Patent Application Number 10-2011-0046889 filed in the Korean Intellectual Property Office on May 18, 2011, the entire contents of which application are incorporated herein for all purposes by this reference.

### BACKGROUND OF INVENTION

1. Field of Invention

The present invention relates to a particulate filter for a vehicle and an exhaust system including the same. More particularly, the present invention relates to a particulate filter for a vehicle which burns particulates or soots trapped in the particulate filter efficiently and an exhaust system including the same.

2. Description of Related Art

Generally, exhaust gas flowing out through an exhaust manifold from an engine is driven into a catalytic converter mounted at an exhaust pipe and is purified therein. After that, the noise of the exhaust gas is decreased while passing through a muffler and then the exhaust gas is emitted into the air through a tail pipe.

A diesel oxidation catalyst (DOC) is one type of such catalytic converters. The diesel oxidation catalyst oxidizes hydrocarbon (HC), carbon monoxide (CO), and nitrogen oxide (NOx) contained in the exhaust gas.

In addition, a particulate filter is mounted on the exhaust pipe, and the particulate filter traps particulate matters (PM) (or soot) contained in the exhaust gas. If excessive soot, however, is trapped in the particulate filter, the exhaust gas is hard to pass through the particulate filter and thus a pressure of the exhaust gas becomes high. High pressure of the exhaust gas deteriorates engine performance and damages the particulate filter. Therefore, if an amount of the soot trapped in the particulate filter is larger than a predetermined amount, a temperature of the exhaust gas is raised and the soot trapped in the particulate filter is burned. This process is called a regeneration of the particulate filter.

Generally, the regeneration of the particulate filter is performed by post-injecting a fuel into a combustion chamber of an engine. That is, the post-injected fuel is oxidized at the diesel oxidation catalyst mounted on the exhaust pipe, and the temperature of the exhaust gas is raised by an oxidation heat generated at oxidation so as to burn the soot trapped in the particulate filter.

For regenerating the particulate filter, the temperature of the exhaust gas is higher than or equal to 600° C. (in this specification, the temperature of the exhaust gas required for regenerating the particulate filter is called ‘regeneration temperature’). However, it may be hard to raise the temperature of the exhaust gas higher than the regeneration temperature in a vehicle running at a specific condition. For example, in a case that the vehicle runs at an idle state or at a low speed/low load state, a maximum temperature of the exhaust gas which can be raised by the post-injection is approximately 450° C.-500° C. because the temperature of the exhaust gas is too low. In this case, the particulate filter cannot be regenerated and thus additional means for raising the temperature of the exhaust gas to a temperature higher than the regeneration temperature are required.

The above information disclosed in this Background section is only for enhancement of understanding of the background of the invention and therefore it may contain information that does not form the prior art that is already known in this country to a person of ordinary skill in the art.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention have been made in an effort to provide a particulate filter and an exhaust system using the same having advantages of raising a temperature of an exhaust gas to a temperature higher than a regeneration temperature without deteriorating fuel consumption in a vehicle running at an idle state or a low speed/low load state.

Features of exemplary particulate filters of the present invention may include: a first layer composed of a first hydrocarbon trap absorbing hydrocarbon contained in an exhaust gas at a low temperature and a second layer composed of a first oxidizing catalyst oxidizing the hydrocarbon contained in the exhaust gas, wherein the hydrocarbon absorbed at the first layer is released at a high temperature, and the released hydrocarbon is oxidized at the second layer so as to raise a temperature of the exhaust gas.

The first hydrocarbon trap may be a beta zeolite. The beta zeolite may include silica and alumina, and a weight ratio of the silica to the alumina may be approximately 24-38%. In addition, the amount of the beta zeolite may be approximately 30-50% of the amount of a wash-coat.

The particulate filter may further include: at least one inlet channel having one open end through which the exhaust gas flows in and one closed end, at least one outlet channel having one closed end and one open end through which the exhaust gas flows out, and a wall defining a boundary between adjacent the at least one inlet channel and the at least one outlet channel, and configured to allow the exhaust gas flow from the at least one inlet channel to the at least outlet channel. The first layer and the second layer are disposed respectively on at least one of an interior circumference of the at least one inlet channel and an interior circumference of the at least outlet channel.

The first layer and the second layer may be disposed at the interior circumference of the at least one inlet channel, wherein the first layer is disposed on the wall, and the second layer is disposed on the first layer. The first layer may also be disposed at the interior circumference of the at least one inlet channel and the second layer is disposed at the interior circumference of the at least one outlet channel. Alternatively, the first layer and the second layer may be disposed at the interior circumference of the at least one inlet channel, wherein the second layer is disposed on the wall, and the first layer is disposed on the second layer.

The wall may be made of a porous material such that the exhaust gas can pass through the wall but particulate matters contained in the exhaust gas cannot pass through the wall. The wall may have a porosity of approximately 50% or above.

Exemplary exhaust systems with exemplary particulate filters according to the present invention may include an oxidation catalyst oxidizing materials contained in an exhaust gas, and a particulate filter disposed at a downstream of the oxidation catalyst and trapping soot contained in the exhaust gas, wherein the particulate filter is the particulate filter according to the present invention. The oxidation catalyst may be a diesel oxidation catalyst.

The diesel oxidation catalyst may include a third layer composed of a second hydrocarbon trap absorbing the hydrocarbon contained in the exhaust gas at a low temperature and a fourth layer composed of a second oxidizing catalyst oxidizing the hydrocarbon contained in the exhaust gas. The hydrocarbon absorbed at the third layer is released at a high temperature and the released hydrocarbon is oxidized at the fourth layer or the second layer so as to raise the temperature of the exhaust gas.

The second hydrocarbon trap may be a beta zeolite. The beta zeolite may include silica and alumina and the weight ratio of the silica to the alumina may be approximately 24-38%. The amount of the beta zeolite may be approximately 30-50% of that of a wash-coat.

The third layer may be disposed on a carrier and the fourth layer may be disposed on the third layer.

The particulate filter and the diesel oxidation catalyst may be formed integrally, with the diesel oxidation catalyst disposed in front of the particulate filter.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary exhaust system according to the present invention.

FIG. 2 is a partial cross-sectional view of an exemplary particulate filter according to the present invention.

FIG. 3 is a partial cross-sectional view of another exemplary particulate filter according to the present invention.

FIG. 4 is a partial cross-sectional view of yet another exemplary particulate filter according to the present invention.

FIG. 5 is a schematic diagram illustrating the operation of an exemplary exhaust system according to the present invention when the temperature of the exhaust gas is low.

FIG. 6 is a schematic diagram illustrating the operation of an exemplary exhaust system according to the present invention when the temperature of the exhaust gas is high.

FIG. 7 is a schematic diagram showing an exemplary diesel oxidation catalyst and an exemplary particulate filter integrally formed in an exemplary exhaust system according to the present invention.

FIG. 8 is a graph showing the outlet temperature of an exemplary particulate filter vs. the idle running time for a case where a vehicle with an exemplary exhaust system according to the present invention runs at an idle state and the exemplary particulate filter is regenerated after a period of time.

FIG. 9 is a graph showing the outlet temperature of an exemplary particulate filter vs. time for a vehicle with an exemplary exhaust system according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

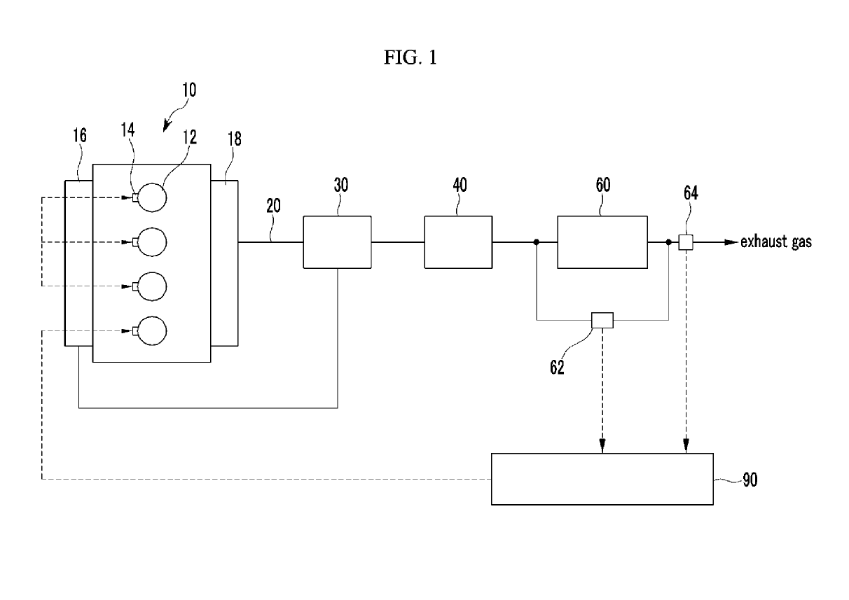

FIG. 1 is a schematic diagram of an exhaust system according to various embodiments of the present invention. As shown in FIG. 1, the exhaust system includes an engine 10, an exhaust pipe 20, an exhaust gas recirculation (EGR) apparatus 30, a diesel oxidation catalyst (DOC) 40, a particulate filter 60, and a control portion 90.

The engine 10 burns an air-fuel mixture in which fuel and air are mixed so as to convert chemical energy. into mechanical energy. The engine 10 is connected to an intake manifold 16 so as to receive the air in a combustion chamber 12, and is connected to an exhaust manifold 18 such that exhaust gas generated in a combustion process is gathered in the exhaust manifold 18 and is exhausted to the exterior. An injector (or multiple injectors) 14 is mounted in the combustion chamber 12 so as to inject the fuel into the combustion chamber 12.

In addition, an engine having various compression ratios, preferably a compression ration lower than or equal to 16.5, may be used.

The exhaust pipe 20 is connected to the exhaust manifold 18 so as to exhaust the exhaust gas to the exterior of a vehicle. The DOC 40 and the particulate filter 60 is mounted on the exhaust pipe 20 so as to remove particulate matters (PM), hydrocarbon, carbon monoxide, and nitrogen oxide, or other harmful compositions, contained in the exhaust gas. For this purpose, a denitrification catalyst (DeNOx catalyst) or a selective catalytic reduction (SCR) apparatus which remove the nitrogen oxide or other harmful materials may be mounted on the exhaust pipe 20. Although only the particulate filter is disclosed in detail in this application, it is to be understood that the present invention is not limited to the particulate filter. Inclusion of a DeNOx catalyst or a SCR apparatus as well as the particulate filter 60 mounted on the exhaust pipe 20 is within the range of the present invention.

Herein, the hydrocarbon represents all compounds consisting of carbon and hydrogen contained in the exhaust gas and the fuel in this specification. Therefore, it is to be understood that carbon monoxide is included in hydrocarbon.

The exhaust gas recirculation apparatus 30 is mounted at the exhaust pipe 20, and the exhaust gas exhausted from the engine 10 passes through the exhaust gas recirculation apparatus 30. In addition, the exhaust gas recirculation apparatus 30 is connected to the intake manifold 16 so as to control the combustion temperature by mixing a portion of the exhaust gas with the air. Such combust temperature is controlled by the control portion 90. That is, the control portion 90 turns on or off an EGR valve provided at the exhaust gas recirculation apparatus 30 so as to control an amount of the exhaust gas supplied to the intake manifold 16.

The DOC 40 is mounted on the exhaust pipe 20 downstream of the exhaust gas recirculation apparatus 30. The DOC 40 oxidizes hydrocarbon (HC) in the exhaust gas into carbon dioxide (CO2). In addition, the DOC 40 oxides nitrogen monoxide (NO) in the exhaust gas into nitrogen dioxide (NO2).

The particulate filter 60 is mounted on the exhaust pipe 20 downstream of the DOC 40. The particulate filter 60 traps particulate matters contained in the exhaust gas passing through the exhaust pipe 20.

In addition, a pressure difference sensor 62 is mounted at the exhaust pipe 20. The pressure difference sensor 62 detects a pressure difference between an inlet portion and an outlet portion of the particulate filter 60 and transmits a signal corresponding thereto to the control portion 90. The control portion 90 is adapted to regenerate the particulate filter 60 when the pressure difference detected by the pressure difference sensor 62 is larger than or equal to a predetermined value. In this case, the injector 14 post-injects the fuel so as to burn soot trapped in the particulate filter 60.

A temperature sensor 64 is mounted at the exhaust pipe 20 downstream of the particulate filter 60 so as to detect a temperature of an exhaust gas passing through the particulate filter 60, and transmits a signal corresponding thereto to the control portion 90.

The control portion 90 receives the signals corresponding to the pressure difference and the temperature respectively from the pressure difference sensor 62 and the temperature sensor 64, and controls an operation of the injector 14. In further detail, if the pressure difference detected by the pressure difference sensor 62 is larger than or equal to the predetermined value, the post-injection is performed so as to regenerate the particulate filter 60. In addition, if the temperature detected by the temperature sensor 64 is lower than or equal to a predetermined value during the regeneration of the particulate filter 60, the injector 14 is controlled to increase an amount of the post-injection. Since such an operation of the control portion 90 is well-known to a person of an ordinary skill in the art, a detailed description will be omitted.

In addition to the pressure difference and the temperature, other parameters, such as concentration of hydrocarbon, can be measured and used as control signals.

Hereinafter, the particulate filter 60 according to various embodiments of the present invention will further be disclosed.

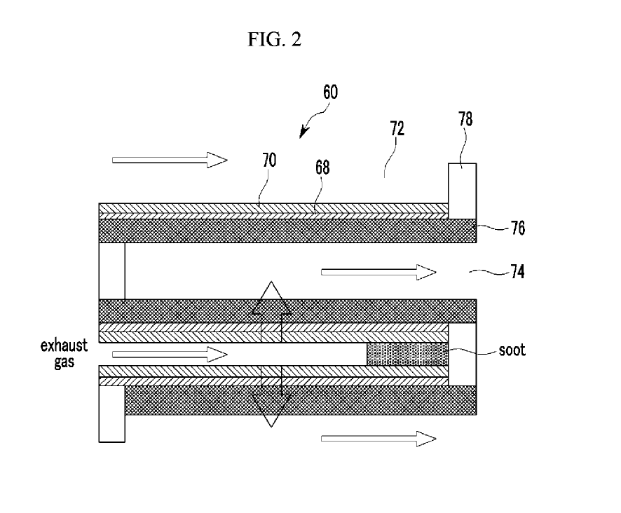

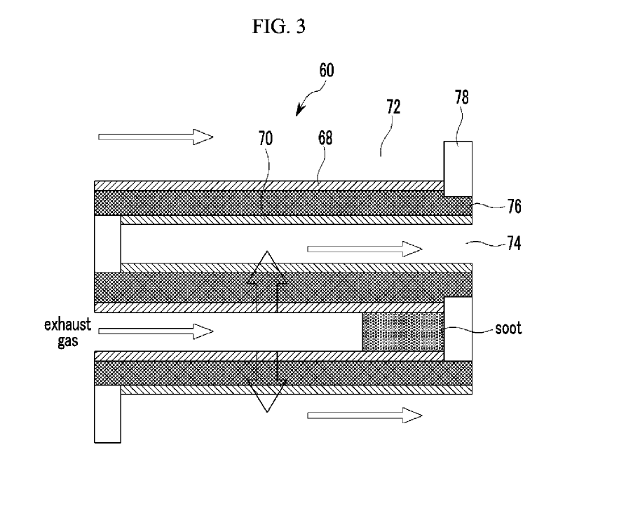

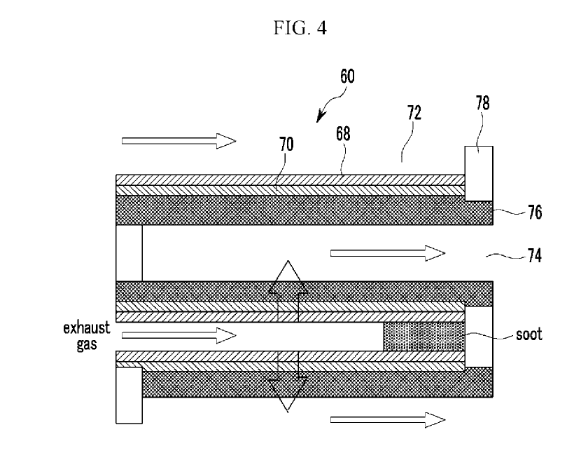

FIG. 2 is a partial cross-sectional view of a particulate filter according to various embodiments of the present invention; FIG. 3 is a partial cross-sectional view of a particulate filter according to other embodiments of the present invention; and FIG. 4 is a partial cross-sectional view of a particulate filter according to yet other embodiments of the present invention.

As shown in FIG. 2 to FIG. 4, the particulate filter 60 according to various embodiments of the present invention includes a plurality of channels 72 and 74 therein. The channel 72 and 74 is divided into an inlet channel 72 and an outlet channel 74.

The inlet channel 72 is a channel through which the exhaust gas passing through the DOC 40 flows in. For this purpose, one end (a left end in the drawings) of the inlet channel 72 is open and the other end (a right end in the drawings) is closed by a channel plug 78.

The outlet channel 74 is a channel through which the exhaust gas in the particulate filter 60 flows out. For this purpose, one end (a left end in the drawings) of the outlet channel 74 is closed by the channel plug 78 and the other end (a right end in the drawings) is open.

The inlet channel 72 and the outlet channel 74 are substantially parallel with each other. A wall 76 is formed between neighboring inlet channel 72 and outlet channel 74 so as to define a boundary between the inlet channel 72 and the outlet channel 74. The wall 76 is formed by porous materials such that the exhaust gas can pass through the wall but the particulate matters (i.e., soot) contained in the exhaust gas cannot pass through it. Therefore, the exhaust gas flows in the particulate filter 60 through the inlet channel 72, penetrates the wall 76, and then flows out from the particulate filter 60 through the outlet channel 74. In this process, the soot is trapped at the other end portion of the inlet channel 72. In various embodiments, the wall has porosity of more than 50%, but is not limited to this.

The particulate filter 60 further includes a first layer 68 on which a first hydrocarbon trap is coated and a second layer 70 on which a first oxidizing catalyst is coated.

Variety of materials can be used as the hydrocarbon trap. In various embodiments, a beta zeolite is used as the first hydrocarbon trap. The beta zeolite has a 12-ring structure, and includes silica (SiO2) and alumina (Al2O3). In various embodiments, a weight ratio of the silica to the alumina is approximately 24-38%. The first hydrocarbon trap absorbs the hydrocarbon at a temperature lower than a predetermined temperature (e.g., approximately 250° C.) and releases the absorbed hydrocarbon at a temperature higher than or equal to the predetermined temperature.

Any oxidizing catalyst used in an exhaust system for a vehicle can be used as the first oxidizing catalyst. The oxidizing catalyst including platinum (Pt) and palladium (Pd) is widely used in the exhaust system for the vehicle, but is not limited to this.

In various embodiments, an amount of the beta zeolite is approximately 30-50% of that of a wash-coat, but is not limited to this. Herein, the amount of the wash-coat is sum of an amount of the beta zeolite and an amount of the first oxidizing catalyst.

The first layer 68 and the second layer 70 are disposed at least one of interior circumferences of the inlet channel 72 and the outlet channel 74.

As shown in FIG. 2, the first layer 68 and the second layer 70 are disposed at only the inlet channel 72. In addition, the first layer 68 is disposed on the wall 76, and the second layer 70 is disposed on the first layer 68. In this case, a portion of the hydrocarbon contained in the exhaust gas passing through the inlet channel 72 is oxidized at the second layer 70 and the other portion of the hydrocarbon is absorbed at the first layer 68. After that, the exhaust gas from which some amount of the hydrocarbon is removed is exhausted from the particulate filter 60 through the outlet channel 74.

As shown in FIG. 3, the first layer 68 is disposed on the wall 76 of the inlet channel 72 and the second layer 70 is dispose on the wall 76 of the outlet channel 74. In this case, a portion of the hydrocarbon contained in the exhaust gas passing through the inlet channel 72 is absorbed at the first layer 68, and the exhaust gas goes to the outlet channel 74. After that, the other portion of the hydrocarbon contained in the exhaust gas is oxidized at the second layer 70. According to the particulate filter 60 shown in FIG. 3, increase in a back pressure according to the arrangement of the first layer 60 and the second layer 70 is minimized.

As shown in FIG. 4, the first layer 68 and the second layer 70 are disposed at only the inlet channel 72. In addition, the second layer 70 is disposed on the wall 76 and the first layer 68 is disposed on the second layer 70. In this case, a portion of the hydrocarbon contained in the exhaust gas passing through the inlet channel 72 is absorbed at the first layer 68 and the other portion is oxidized at the second layer 70. After that, the exhaust gas from which some amount of the hydrocarbon is removed is exhausted from the particulate filter 60 through the outlet channel 74. The particulate filter 60 shown in FIG. 4, compared to the particulate filters 60 shown in FIG. 2 and FIG. 3 can absorb the hydrocarbon at a higher temperature.

Hereinafter, operations of the DOC 40 and the exhaust system according to various embodiments of the present invention will be described in detail.

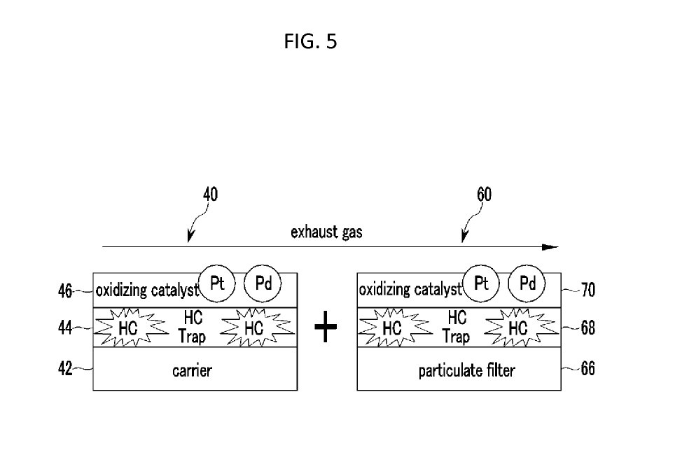

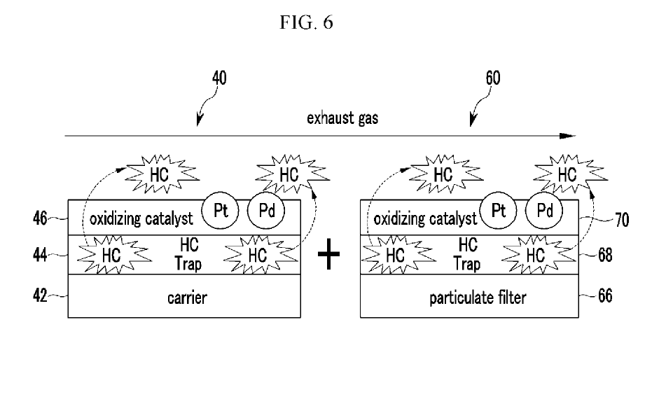

FIG. 5 is a schematic diagram for explaining an operation of an exhaust system according to various embodiments of the present invention where a temperature of an exhaust gas is low, and FIG. 6 is a schematic diagram for explaining an operation of an exhaust system according to various embodiments of the present invention where a temperature of an exhaust gas is high.

As shown in FIG. 5 and FIG. 6, the DOC 40 according to various embodiments of the present invention includes a carrier 42, a third layer 44, and a fourth layer 46.

A carrier used in the oxidizing catalyst for a vehicle can be used as the carrier 42. The third layer 44 is disposed on the carrier 42 and a second hydrocarbon trap is coated thereon. The second hydrocarbon trap may be the same as or be different from the first hydrocarbon trap in terms of material compositions, physical dimensions, weights, ratios, and/or other chemical and physical parameters. In various embodiments, a beta zeolite is used as the second hydrocarbon trap. The beta zeolite has 12-ring structure and includes silica (SiO2) and alumina (Al2O3). In various embodiments, a weight ratio of the silica to the alumina is approximately 24-38%. The second hydrocarbon trap absorbs the hydrocarbon at a temperature lower than a predetermined temperature (e.g., approximately 250° C.) and releases the absorbed hydrocarbon at a temperature higher than or equal to the predetermined temperature.

The fourth layer 46 is disposed on the third layer 44 and the second oxidizing catalyst is coated thereon. The second oxidizing catalyst may be the same as or be different from the first oxidizing catalyst in terms of material compositions, physical dimensions, weights, ratios, and/or other chemical and physical parameters. An oxidizing catalyst used in an exhaust system for a vehicle can be used as the second oxidizing catalyst. The oxidizing catalyst including platinum (Pt) and palladium (Pd) is widely used in the exhaust system for the vehicle, but is not limited to this.

In various embodiments, an amount of the beta zeolite is approximately 30-50% of that of a wash-coat, but is not limited to this. Herein, the amount of the wash-coat is sum of an amount of the beta zeolite and an amount of the second oxidizing catalyst.

As shown in FIG. 5, when a temperature of the exhaust gas is low (i.e., the temperature of the exhaust gas is lower than the predetermined temperature, e.g., approximately 250° C.), a portion of the hydrocarbon contained in the exhaust gas is oxidized at the fourth layer 46 and the second layer 70, and the other portion of the hydrocarbon contained in the exhaust gas is absorbed at the third layer 44 and the first layer 68.

At this state, if the temperature of the exhaust gas becomes high (i.e., the temperature of the exhaust gas becomes higher than or equal to the predetermined temperature), the hydrocarbon absorbed at the third layer 44 and the first layer 68 is released and the released hydrocarbon and another portion of the hydrocarbon contained in the exhaust gas are oxidized at the fourth layer 46 and the second layer 70. Therefore, the temperature of the exhaust gas rises further and regeneration of the particulate filter 60 is smoothly performed.

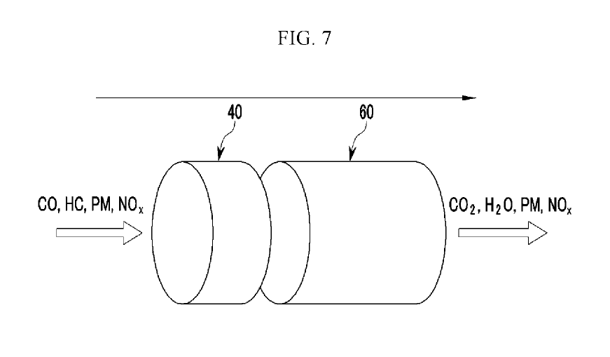

FIG. 7 is a schematic diagram for showing a diesel oxidation catalyst and a particulate filter integrally formed with each other in an exhaust system according to various embodiments of the present invention.

As shown in FIG. 7, the DOC 40 and the particulate filter 60 may be integrally formed with each other. In various embodiments, the DOC 40 is disposed at a front portion of the particulate filter 60.

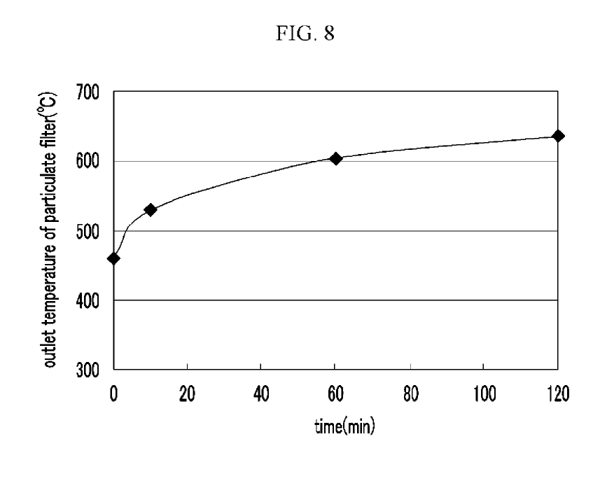

FIG. 8 illustrates the outlet temperature of an exemplary particulate filter vs. the idle running time for a case where a vehicle with an exemplary exhaust system according to the present invention runs at an idle state and the exemplary particulate filter is regenerated after a period of time.

As shown in FIG. 8, at the beginning without an idle running, an outlet temperature of the particulate filter 60 is about 460° C. In this case, since the temperature of the exhaust gas passing through the particulate filter 60 is lower than a regeneration temperature (about 600° C.), the particulate filter 60 is not regenerated.

After two hours idle running, the outlet temperature of the particulate filter 60 is higher than the regeneration temperature and the particulate filter 60 is regenerated. During the idle running, since the temperature of the exhaust gas is low, the hydrocarbon contained in the exhaust gas is absorbed in the third layer 44 and the first layer 68. At this state, if post-injection is performed so as to regenerate the particulate filter 60, the temperature of the exhaust gas is raised and the hydrocarbon absorbed at the third layer 44 and the first layer 68 is released and oxidized. The temperature of the exhaust gas is quickly raised higher than the regeneration temperature by oxidation heat generated at this process.

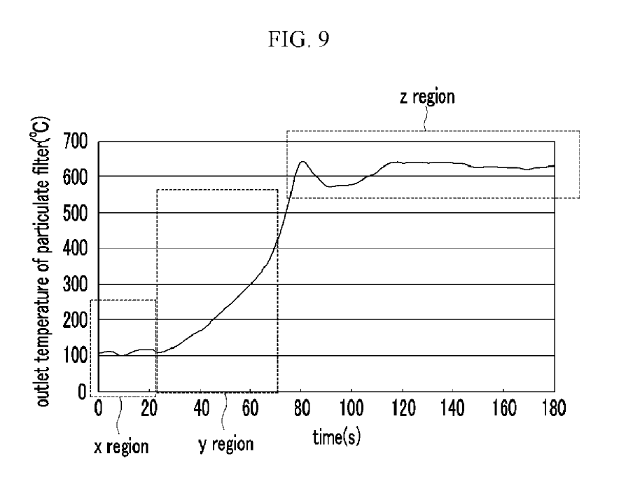

FIG. 9 illustrates an outlet temperature of a particulate filter vs. time for a vehicle with an exhaust system according to various embodiments of the present invention.

As shown in FIG. 9, the temperature of the exhaust gas is low in an X region because of the idle running. That is, the hydrocarbon contained in the exhaust gas is absorbed at the third layer 44 and the first layer 68 in the X region.

The control portion 90 performs the post-injection so as to regenerate the particulate filter 60 in a Y region. At this time, since the hydrocarbon absorbed at the third layer 44 and the first layer 68 is released and oxidized, the temperature of the exhaust gas rises quickly.

Since the temperature of the exhaust gas is higher than or equal to the regeneration temperature in a Z region, the particulate filter 60 is regenerated.

As described above, a temperature of an exhaust gas in a vehicle running at an idle state or at a low speed/low load state can be raised higher than or equal to a regeneration temperature without large amount of fuel usage according to various embodiments of the present invention. Therefore, deterioration of fuel economy may be prevented.

In addition, engine performance may be improved and damage of the particulate filter may be prevented by efficiently regenerating the particulate filter.

For convenience in explanation and accurate definition in the appended claims, the terms “higher” or “lower”, “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A particulate filter for a vehicle, comprising:
a first layer composed of a first hydrocarbon trap absorbing a portion of hydrocarbon contained in an exhaust gas at a low temperature; and
a second layer composed of a first oxidizing catalyst oxidizing the hydrocarbon contained in the exhaust gas,
wherein the hydrocarbon absorbed at the first layer is released at a high temperature, and the released hydrocarbon is oxidized at the second layer raising a temperature of the exhaust gas.

2. The particulate filter of claim 1, wherein the first hydrocarbon trap is a beta zeolite.

3. The particulate filter of claim 2, wherein the beta zeolite includes silica and alumina, and a weight ratio of the silica to the alumina is approximately 24-38%.

4. The particulate filter of claim 2, wherein an amount of the beta zeolite is approximately 30-50% of an amount of a wash-coat.

5. The particulate filter of claim 1, further comprising:
at least one inlet channel having one open end through which the exhaust gas flows in and one closed end;
at least one outlet channel having one closed end and one open end through which the exhaust gas flows out; and
a wall defining a boundary between adjacent the at least one inlet channel and the at least one outlet channel, and configured to allow the exhaust gas flow from the at least one inlet channel to the at least outlet channel,
wherein the first layer and the second layer are disposed respectively on at least one of an interior circumference of the at least one inlet channel and an interior circumference of the at least outlet channel.

6. The particulate filter of claim 5, wherein the first layer and the second layer are disposed at the interior circumference of the at least one inlet channel, wherein the first layer is disposed on the wall, and the second layer is disposed on the first layer.

7. The particulate filter of claim 5, wherein the first layer is disposed at the interior circumference of the at least one inlet channel and the second layer is disposed at the interior circumference of the at least one outlet channel.

8. The particulate filter of claim 5, wherein the first layer and the second layer are disposed at the interior circumference of the at least one inlet channel, wherein the second layer is disposed on the wall, and the first layer is disposed on the second layer.

9. The particulate filter of claim 5, wherein the wall has a porosity of approximately 50% or above.

10. An exhaust system, comprising:
an oxidation catalyst oxidizing materials contained in an exhaust gas; and
a particulate filter of claim 1 disposed at a downstream of the oxidation catalyst.

11. The exhaust system of claim 10, wherein the oxidation catalyst comprises:
a third layer composed of a second hydrocarbon trap absorbing the hydrocarbon contained in the exhaust gas at a low temperature; and
a fourth layer composed of a second oxidizing catalyst oxidizing the hydrocarbon contained in the exhaust gas,
wherein the hydrocarbon absorbed at the third layer is released at a high temperature and the released hydrocarbon is oxidized at the fourth layer or the second layer raising the temperature of the exhaust gas.

12. The exhaust system of claim 11, wherein the second hydrocarbon trap is a beta zeolite.

13. The exhaust system of claim 12, wherein the beta zeolite includes silica and alumina, and a weight ratio of the silica to the alumina is approximately 24-38%.

14. The exhaust system of claim 12, wherein an amount of the beta zeolite is approximately 30-50% of an amount of a wash-coat.

15. The exhaust system of claim 12, wherein the third layer is disposed on a carrier and the fourth layer is disposed on the third layer.

16. The exhaust system of claim 11, wherein the particulate filter and the oxidation catalyst are formed integrally, with the oxidation catalyst disposed in front of the particulate filter.

17. The particulate filter of claim 5, wherein the wall is made of a porous material such that the exhaust gas can pass through the wall but particulate matters contained in the exhaust gas cannot pass through the wall.

18. The exhaust system of claim 10, where in the oxidation catalyst is a diesel oxidation catalyst (DOC).

19. The exhaust system of claim 18, wherein the particulate filter and the oxidation catalyst are formed integrally, with the diesel oxidation catalyst disposed in front of the particulate filter.

20. The particulate filter of claim 1, wherein the high temperature for releasing the hydrocarbon absorbed at the first layer is approximately 600° C. or above.
